(19) United States
(12) Patent Application Publication
(10) Pub. No.: US 2007/0156387 A1
(43) Pub. Date: Jul. 5, 2007

(54) Reliability improvement using signal handler for fault recovery in software emulator

(76) Inventors: Russell W. Guenthner, Glendale, AZ (US); Stefan R. Bohult, Phoenix, AZ (US); David W. Selway, Phoenix, AZ (US); Clinton B. Eckard, McMinnville, TN (US)

Correspondence Address: Dr. Russell W. Guenthner;Bull HN Information Systems Inc. - MS B55, 13430 N. Black Canyon Highway, Phoenix, AZ, 85029, US

(21) Appl. No.: 11/323,969

(22) Filed: Dec. 29, 2005

(51) Int. Cl. G06F 9/455

(52) U.S. Cl. 703/26

(57) ABSTRACT

As fast and powerful commodity processors have been developed, it has become practical to emulate on platforms built using commodity processors the proprietary hardware systems of powerful older computers that have been developed and honed over many years. The reliability and robustness of the legacy system and its emulated replacement are of utmost importance. Since the emulation system software is new and complex it may have undiscovered errors in coding which if encountered may result in an abort of the emulation program itself. This software emulation program abort is akin to a logic failure or bug in the legacy system hardware. Utilizing a signal handler in analysis and recovery from coding errors, while not taking greater risk of data corruption, increases the stability and robustness of the emulated computer system and is akin to hardware error correction in the legacy system hardware design.

### FIELD OF THE INVENTION

This invention relates to the art of computer system emulation and, more particularly, to a host computer system in which the instruction set of legacy system hardware design is emulated by a software program to thus preserve legacy systems and software. More particularly, this invention relates to improving the reliability, availability and serviceability of a software emulator by utilizing host system hardware and software and a signal handler to detect and initiate recovery from certain software faults in the emulator.

### BACKGROUND OF THE INVENTION

Users of obsolete mainframe computers running a proprietary operating system may have a very large investment in proprietary application software and, further, may be comfortable with using the application software because it has been developed and improved over a period of years, even decades, to achieve a very high degree of reliability and efficiency.

As manufacturers of very fast and powerful “commodity” processors continue to improve the capabilities of their products, it has become practical to emulate the proprietary hardware and operating systems of powerful older computers on platforms built using commodity processors such that the manufacturers of the older computers can provide new systems which allow their customers to continue to use their highly-regarded proprietary software on state-of-the-art new computer systems by emulating the older computer in software that runs on the new systems.

Accordingly, computer system manufacturers are developing such emulator systems for the users of their older systems, and the emulation process used by a given system manufacturer is itself subject to ongoing refinement and increases in efficiency and reliability.

Some historic computer systems now being emulated by software running on commodity processors have achieved performance which approximates or may even exceed that provided by legacy hardware system designs. An example of such hardware emulation is the Bull HN Information Systems (descended from General Electric Computer Department and Honeywell Information Systems) DPS 9000 system which is being emulated by a software package running on a Bull NovaScale system which is based upon an Intel Itanium 2 Central Processor Unit (CPU). The 64-bit Itanium processor is used to emulate the Bull DPS 9000 36-bit memory space and the GCOS 8 instruction set of the DPS 9000. Within the memory space of the emulator, the 36-bit word of the “target” DPS 9000 is stored right justified in the least significant 36 bits of the “host” (Itanium) 64-bit word. The upper 28 bits of the 64-bit word are typically zero for “legacy” code. Sometimes, certain specific bits in the upper 28 bits of the containing word are used as flags or for other temporary purposes, but in normal operation these bits are usually zero and in any case are always viewed by older programs in the “emulated” view of the world as being non-existent. That is, only the emulation program itself uses these bits.

In the development of the emulator system, careful attention is typically devoted to ensuring exact duplication of the legacy hardware behavior so that legacy application programs will run without change and even without recompilation. Exact duplication of legacy operation is highly desirable to accordingly achieve exactly equivalent results during execution.

In order to achieve performance in an emulated system that at least approximates that achieved by the legacy system hardware, or in more general terms, in order to maximize overall performance, it is necessary that the code that performs the emulation be very carefully designed and very “tightly” coded in order to minimize breaks and maximize performance. These considerations require careful attention to the lowest level design details of the host system hardware, that is, the hardware running the software that performs the emulation. It also requires employing as much parallelization of operations as possible.

An Intel Itanium series 64-bit CPU is an excellent exemplary platform for building a software emulator of a legacy instruction set because it offers hardware resources that enable a high degree of potential parallelism in the hardware pipeline of the Itanium CPU. The Itanium CPU also provides instructions that allow for fast decision making and guidance by the software as to the most likely path of program flow for a reduction in instruction fetch breaks and overall improved performance. In particular, the Itanium architecture provides instructions that allow preloading of a “branch register” which informs the hardware of the likely new path of the instructions to be executed, with the “branch” instruction itself actually happening later. This minimizes the CPU pipeline breaks that are characteristically caused by branch instructions, and allows for typically well predicted branch instructions to be processed efficiently without CPU pipeline breaks wasting cycles. The branch look-ahead hardware of the Itanium CPU, and in particular a specific mechanism for loading and then using a branch register, allows for the emulation software to achieve a higher degree of overlap and, as a result, higher performance in emulated legacy system instruction processing.

Reference may be taken to co-pending U.S. application Ser. No. 11/174,866 entitled “Lookahead Instruction Fetch Process for Improved Emulated Instruction Performance” by Russell W. Guenthner et al, filed Jun. 6, 2005, and assigned to the same Assignee as the present application for a more complete exposition of the advantages of selecting a host processor having the characteristics of the Intel Itanium series processors for emulating legacy software.

The development of software which provides for emulation of the legacy software instruction set on the host machine is complicated, and the requirements on performance are extreme. An approach which allows for ease of development and also provides the ultimate performance is to develop the code first in a high-level language, and then once the functionality and approach are precisely defined, to develop analogous code in assembly language. Because of the complexity it is also probable that in a final product some of the source code will be in assembly and some will be in a more easily maintained and understood higher level language such as “C” or “C++”.

Two major requirements of the emulation software are 1) to achieve precise and exact emulation of the legacy instruction set, and 2) to achieve the highest possible performance. These two requirements are sometimes conflicting.

In any software emulation of hardware there are pieces of code which are concerned with checking for error conditions and exceptions. Since performance is critical the code must be carefully crafted to avoid “wasting” unnecessary time doing all the checks that the legacy system hardware might have done in parallel with other operations. Checking in software for the many exceptions that may have been detected by the legacy hardware is time-consuming and a potentially large detriment to performance.

The emulation software runs on a machine called the host system. The host system is itself a computer system which has its own exception and fault checking mechanisms built into the host system hardware and if used, also in the operating system of the host system. The exceptions and checks may be similar or quite different from the legacy system being emulated. These exceptions typically must be avoided by writing the emulation software so that it does not typically fault or do things which would cause system or application program errors.

If an error is detected by the host system hardware and operating system software there are typically two options for “handling” the error condition. Typically, the application program is aborted. In more advanced systems, a mechanism commonly called a “signal handler” may be invoked by a coordinated response of host system's operating system and the underlying hardware upon which it is running. In any operating system these pieces of code are typically quite machine dependent. The signal handler is code that is written by the application developer and that code is invoked on behalf of the application program when specifically selected hardware or system errors are detected. This gives the application programmer a chance to recover or process the host system detected errors in any desired way and is a much improved alternative to simply aborting the program.

It can also be observed that not all of the legacy code being emulated from the legacy system is of the same level of criticality. For example, an application program can abort or be aborted without bringing down the entire emulated system. Certain pieces of the operating system are also much more critical than other pieces. Some programs can be aborted and restarted without problem, and many “mainframe” programs are designed to allow for this. A software approach to hardware detected errors inside the emulator is akin to hardware error detection, correction and recovery.

### OBJECTS OF THE INVENTION

Accordingly it would be an advantage to provide for a solution and methodology within a computer system hardware emulation that allows for the signal handler of the host system hardware and operating system to be utilized by the software emulation program with the objectives of improving the stability and reliability of the software emulation program itself. This is done in a manner such that the checking for selected special conditions that would normally be required of the software emulation code in the method of the prior art would be left unchecked by the software emulation program. These certain special conditions would now instead be detected and caught by the host system hardware and software. Then, control is passed back to the emulation software program in a manner such that proper processing and recovery from the exception in the manner of the emulated legacy system hardware would take place.

This implementation allows certain checking by the software emulation program to not need to be done in software and allows for increased performance of the overall emulation. Further enhancement of these same facilities for signal handling also allows for increased reliability in the emulation system itself, and especially in overall legacy system stability and are the objects of this invention.

These further enhancements include a provision for distinguishing between emulation of hardware instructions which are part of the legacy system operating system, or “system” code versus instructions which are part of an “application” that is not part of the operating system itself. Once this distinction can be made the signal handling can be programmed such that certain signals which are detected while emulating application program code will cause the abort of only that application program while leaving the legacy operating system running. This approach increases the stability and availability of the overall emulated legacy system.

It is to these ends that the present invention is directed.

### SUMMARY OF THE INVENTION

When the emulated legacy system is a large mainframe handling multiple programs simultaneously and continuously, the selection and subsequent control of the emulator is not trivial. Software emulation of a hardware system requires that the software emulation appear to act like hardware in that it switches between and performs many tasks for many users or programs simultaneously. The same software emulation system which is utilized to run a user's job, is also simultaneously used to emulate the processing of instructions for both the operating system and the I/O system. In a large system with multiple users, the same emulation software is used to process jobs from many users, threads, or processes. The software emulation of the “hardware” switches rapidly between the tasks to be done, and as a result spends small slices of time processing many users jobs, threads, or processes.

If errors exist in the coding of the software emulation software, it may be possible that the coding errors will affect only the results of the software emulation of an application program and not the higher level operating system or I/O system. The erroneous coding may affect only a single user and not other users. In this case system reliability can be increased by detecting these conditions and in response to such detection aborting only the job for that user application rather than the entire emulation software program, which could potentially bring down the entire emulation system, operating system and all components. This should be avoided if possible without taking any large risk or sacrifice of system data integrity.

A simple and commonly encountered example of a check in which reliability can be increased would be the hardware detection of a “divide check”. A “divide check” is a commonly used term in the computer industry which means that an attempt has been to tell the hardware to divide by zero. Dividing by zero is potentially a hazard in programming because a divide by zero is a result which should have a quotient with value of infinity. Typically, without a signal handler, a division by zero will cause the operating system to abort any program which executes a hardware divide instruction and encounters a divisor with value zero. This is true for both integer and floating point divides. With a signal handler in place however, the application program is given the opportunity to recover from such a fault and to return to normal processing.

Specifically as related to software emulation of a hardware instruction set, there are two potential categories of problems which may cause a divide check. The first case is when the software emulation program is in error, and for some reason unplanned by the programmer a divide by zero is encountered that was unanticipated. A second case is when the need for checking for a zero divisor is specifically ignored by the emulation software and the host system hardware/software signal of a divide check is relied upon to detect such a condition.

In the first case which is a programming error, there are two further sub-possibilities. The first sub-possibility is that the error is encountered while emulating the instructions which are a part of a user's job, and the second is when the emulation is processing an emulated instruction which is part of the legacy operating system. If the error is encountered while processing instructions which are part of a user's application, there may be no need to “crash” or abort the entire software emulation system. Instead, for certain errors a choice can be made to abort only that specific user's job, and leave the emulation to continue with further processing of other jobs and the operating system itself. This will result in a more robust emulated legacy system. It is understood that certain pieces of operating system code are also less or more critical than others, and that some application programs are very important, but this can be ignored for simplicity in this explanation.

The second case is a potential error which could have been anticipated by the software emulation programmer, but a decision was made, for performance and simplicity reasons, to not anticipate or check for the error condition before using a host machine instruction which may indeed abort. In this case, a signal handler at a high level can detect the error, and then return control to the software emulation code specifically written to recover from such errors. The software emulator can then account for the event which was the hardware exception and finish that specific instruction emulation utilizing special code in the software emulator written to recover from errors in the manner of the original legacy hardware instruction. That is, in response to the signal from the host system hardware that a specific error has occurred, the software emulator can determine which legacy instruction was being emulated and respond in a manner which emulates the response that the legacy hardware system would perform in response to that special situation.

For the second case just described, that of not checking for conditions that could cause potential hardware aborts, the performance of the software code can be potentially better than when a check is made because the instructions required to perform the check are not needed. The response to an error is typically not critical and not a performance impact because the exception conditions typically occur infrequently. For conditions which do occur on a frequent basis, an engineering decision as to which is the most performance approach must be made, especially since the signal handler in a machine such as Linux may take hundreds or even thousands of cycles to respond, recover and return control after the error to the software emulation program.

A further complication which must be resolved in the second case is to determine if any distinction must be made to account for the anomaly that an unanticipated software coding error could cause a hardware fault identical to that which might occur naturally by encountering data which would cause a legacy instruction hardware fault. For the example of a divide check, the response would be different if the software emulation caused a divide check when it was not in the process of emulating a divide instruction, versus if it encountered a divide check while emulating a legacy instruction which actually does a divide. This distinction could be provided to the signal handler as some sort of flag such as the setting of a global variable or register, to tell the signal handler that an expected potential exception type may be encountered and then resetting that flag after the code that may cause it has been completed. Another approach would be to provide information which would allow the software emulation to have knowledge of specifically which instruction locations may detect the “anticipated” hardware errors, and process only those specifically. Hardware aborts detected from other host system program counter locations would be treated as the first case above, that is, determining if the error occurred while processing a legacy system instruction which is part of the legacy operating system code, or a “milder” response for an application program which would allow only the emulation of one program to be aborted.

In the Intel Itanium 2 processor which is the environment for the implementation of the exemplary machine for this invention the assembly language for the machine provides access to hardware registers which allow for the precise location of a hardware fault to be determined and that information given, typically by the operating system, to the software emulation program.

Further consideration as to the specifics of any fault may also be important in the decision as to whether to recover the emulation of the legacy instructions for a specific program, to abort a user application, or to abort the entire emulation process. An example of this would be in analysis of what is commonly called a “segmentation error” by a program which is an access outside the boundaries of memory that are allowed to it. A segmentation error that was attempting to “read” a location in memory outside of its boundaries might be deemed less likely to have corrupted critical system memory components than a segmentation error that signals an attempt to write or “store” into that memory location.

### DESCRIPTION OF THE DRAWING

The subject matter of the invention is particularly pointed out and distinctly claimed in the concluding portion of the specification. The invention, however, both as to organization and method of operation, may best be understood by reference to the following description taken in conjunction with the subjoined claims and the accompanying drawing of which:

FIG. 1 is a high-level block diagram showing a “host” system emulating the operation of a legacy system, running legacy software;

FIG. 2 shows the format of an exemplary simple legacy code instruction that is emulated by emulation software on the host system;

FIG. 3 is a simplified flow chart showing the basic approach to emulating legacy software in a host system;

FIG. 4 is block diagram of a host system processor that is well adapted for use in practicing the present invention;

FIG. 5 is flow diagram illustrating the pseudo-code of exemplary emulation software executing a host system divide instruction as part of the processing for one specific legacy system machine instruction;

FIG. 6 is a flow diagram illustrating checking of a potential condition that may cause a hardware fault before the host system instruction that may fault is executed;

FIG. 7 is a flow diagram illustrating the recovery from a hardware special case condition that was not checked but which was caught by a higher level signal handler; and

FIG. 8 is a diagram illustrating the determination of whether a signaled condition detected while running the emulation software should cause an abort, or recovery and resumption of emulation on behalf of the same program.

### DESCRIPTION OF THE PREFERRED EMBODIMENT(S)

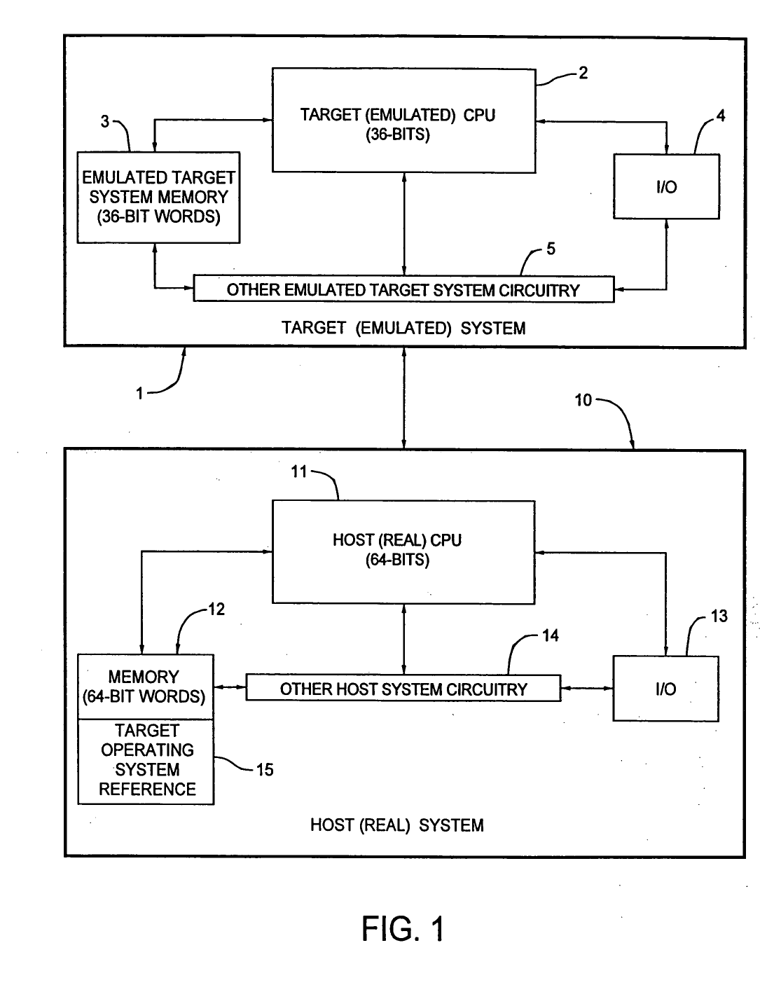

FIG. 1 illustrates an exemplary environment in which the invention finds application. More particularly, the operation of a target (emulated) “legacy” system is emulated by a host (real) system 10. The target system 1 includes an emulated central processing unit (CPU) 2 (which may employ multiple processors), an emulated memory 3, emulated input/output (I/O) 4 and other emulated system circuitry 5. The host (real) system 10 includes a host CPU 11, a host memory 12, host I/O 13 and other host system circuitry 14. The host memory 12 includes a dedicated target operating system reference space 15 in which the elements and components of the emulated system 1 are represented.

The target operating system reference space 15 also contains suitable information about the interconnection and interoperation among the various target system elements and components and a complete implementation in software of the target system operating system commands which includes information on the steps the host system must take to “execute” each target system instruction in a program originally prepared to run on a physical machine using the target system operating system. It can be loosely considered that, to the extent that the target system 1 can be said to “exist” at all, it is in the target operating system reference space 15 of the host system memory 12. Thus, an emulator program running on the host system 2 can replicate all the operations of a legacy application program written in the target system operating system as if the legacy application program were running on a physical target system.

In a current state-of-the-art example chosen to illustrate the invention, a 64-bit Intel Itanium series processor is used to emulate the Bull DPS 9000 36-bit memory space and the instruction set of the DPS 9000 with its proprietary GCOS 8 operating system. Within the memory space of the emulator, the 36-bit word of the DPS 9000 is stored right justified in the least significant 36 bits of the “host” (Itanium) 64-bit word during the emulation process. The upper 28 bits of the 64-bit word are typically zero; however, sometimes, certain specific bits in the “upper” 28 bits of the “containing” word are used as flags or for other temporary purposes. In any case, the upper 28 bits of the containing word are always viewed by the “emulated” view of the world as being non-existent. That is, only the emulation program itself uses these bits or else they are left as all zeroes. Leaving the bits as all zeroes can also be a signal to the software emulator that it is “emulating” a 36-bit instruction, and the non-zero indication would signal a 64-bit instruction.

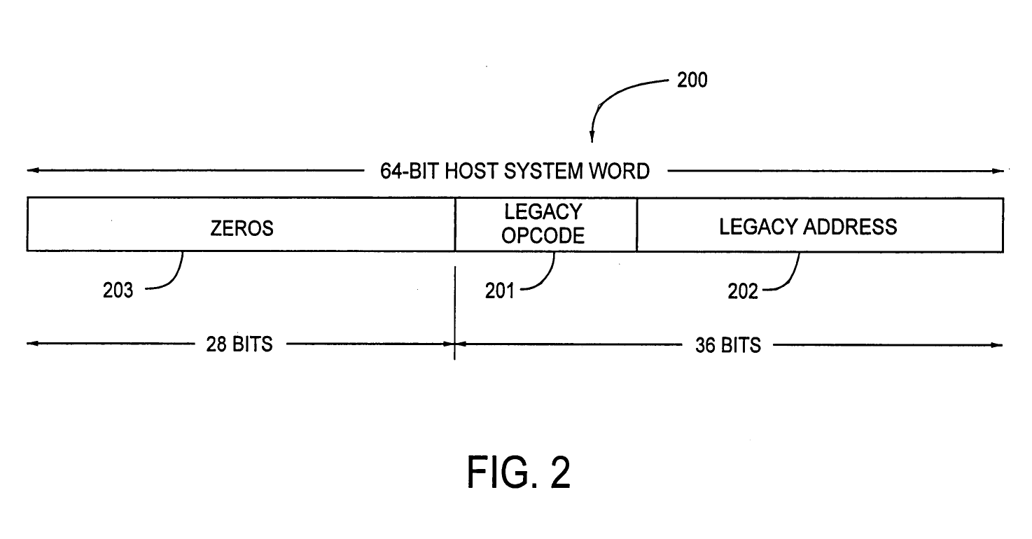

FIG. 2 shows, in a 64-bit host system word 200, the format of a simple 36-bit legacy code instruction word which includes an opcode field 201 and an address or operand field 202 and unused bits which are zeroes 203. Those skilled in the art will appreciate that an instruction word can contain several fields which may vary according to the class of instruction word, but it is the field commonly called the “opcode” which is of particular interest in explaining the present invention. The opcode of the legacy instruction is that which controls the program flow of the legacy program being executed. As a direct consequence the instruction word opcode of each sequential or subsequent legacy instruction controls and determines the overall program flow of the host system emulation program and the program address of the host system code to process each legacy instruction. Thus, the legacy instruction word opcode and the examination and branching of the host system central processor based on the opcode is an important and often limiting factor in determining the overall performance of the emulator. The decision making to transfer program control to the proper host system code for handling each opcode type is unpredictable and dependent on the legacy system program being processed. The order of occurrence and the branching to handle any possible order of instruction opcodes is unpredictable and will often defeat any branch prediction mechanism in the host system central processor which is trying to predict program flow of the emulation program.

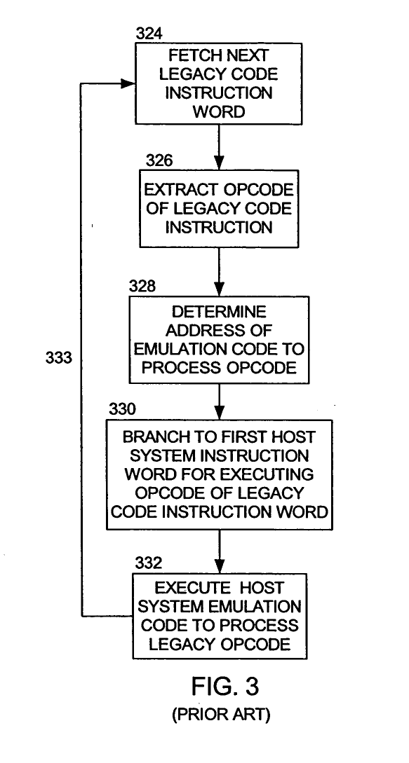

FIG. 3 is a simplified flow chart showing the basic approach to emulating legacy software in a host system. As a first step 324 an emulated instruction word, the legacy code instruction word, is fetched from host system memory. The emulated instruction word is decoded by the emulation software including the extraction of the opcode 326 from the instruction word. This opcode is used to determine the address of the code within the emulation software 328 which will be selected to process that specific opcode. This determination can be made in many ways well known in the art of computer programming. For example, the address can be looked up in a table indexed by the opcode, with the table containing pointers to the routine that will process that particular instruction. An alternative is to arrange the processing code in host system memory such that the address of each piece of opcode processing code can be calculated, rather than looked up in a table. A second alternative commonly used in the high level “C” programming language is to use a “switch” statement to select between alternate execution paths. A third alternative is to use a table of addresses which point to subroutines or functions, and to use the table to look up the address and the make a call to the proper subroutine based upon that address. This third alternative is particularly efficient when the lower level subroutines for handling a specific opcode are written in either “C” or assembly. Continuing as shown in FIG. 3, once the address of the code to process a specific opcode is selected, a branch to the code selected is made 330 with that branch being either a call instruction if the code is implemented as a subroutine, or a simple branch if the code is in the same routine as the branch itself. Then, the actual code to process the instruction as determined by the opcode is executed 332. Finally, once that instruction is processed the code begins the processing of the next instruction 333.

It is noted at this point that in actual practice the steps shown in FIG. 3 are overlapped and performed in parallel. It is also noted that the fetching of the next instruction, and even several instructions ahead can also be performed in parallel with the processing of any particular opcode or instruction. This prefetch and preprocessing by emulation software code is analogous to that performed in hardware when a machine is implemented in real hardware gates and not the emulation software of the subject invention.

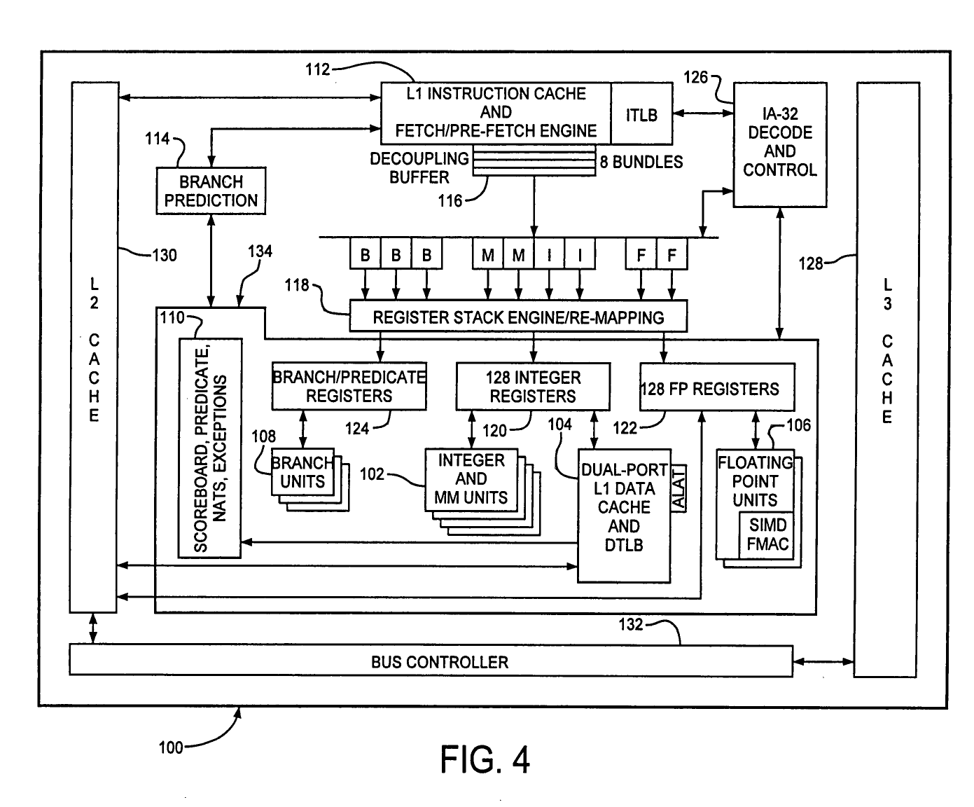

The subject invention can be practiced in host CPUs of any design but is particularly effective in those which include branch prediction registers which assist the hardware in handling branches and also benefits from CPUs employing parallel execution units and having efficient parallel processing capabilities. It has been found, at the state-of-the-art, that the Intel Itanium series of processors is an excellent exemplary choice for practicing the invention. Accordingly, attention is directed to FIG. 4 which is a block diagram of an Intel Itanium processor which will be used to describe the present invention.

The CPU 100 employs Explicitly Parallel Instruction Computing (EPIC) architecture to expose Instruction Level Parallelism (ILP) to the hardware. The CPU 100 provides a six-wide and ten-stage pipeline to efficiently realize ILP.

The function of the CPU is divided into five groups. The immediately following discussion gives a high level description of the operation of each group.

Instruction Processing: The instruction processing group contains the logic for instruction prefetch and fetch 112, branch prediction 114, decoupling coupler 116 and register stack engine/remapping 118.

Execution: The execution group 134 contains the logic for integer, floating point, multimedia, branch execution and the integer and floating point register files. More particularly, the hardware resources include four integer units/four multimedia units 102, two load/store units 104, two extended precision floating point units and two single precision floating point units 106 and three branch units 108 as well as integer registers 120, FP registers 122 and branch and Predicate registers 124. In certain versions of the Itanium 2 architecture, six of the execution units can be utilized by the CPU simultaneously with the possibility of six instructions being started in one clock cycle, and sent down the execution pipeline. Six instructions can also be completed simultaneously.

Control: The control group 110 includes the exception handler and pipeline control. The processor pipeline is organized into a ten stage core pipeline that can execute up to six instructions in parallel each clock period.

IA-32 Execution: The IA-32 instruction group 126 group contains hardware for handling certain IA-32 instructions; i.e., 32-bit word instructions which are employed in the Intel Pentium series processors and their predecessors, sometimes in 16-bit words.

Three levels of integrated cache memory minimize overall memory latency. This includes an L3 cache 128 coupled to an L2 cache 130 under directive from a bus controller 130. Acting in conjunction with sophisticated branch prediction and correction hardware, the CPU speculatively fetches instructions from the L1 instruction cache in block 112. Software-initiated prefetch probes for future misses in the instruction cache and then prefetches specified code from the L2 cache into the L1 cache. Bus controller 132 directs the information transfers among the memory components.

The foregoing will provide understanding by one skilled in the art of the environment, provided by the Intel Itanium series CPU, in which the present invention may be practiced. The architecture and operation of the Intel Itanium CPU processors is described in much greater detail in the Intel publication “Intel® Itanium™ 2 Processor Hardware Developer's Manual” which may be freely downloaded from the Intel website and which is incorporated by reference herein.

The Itanium 2 is presently preferred as the environment for practicing the present invention, but, of course, future versions of the Itanium series processors, or other processors which have the requisite features, may later be found to be still more preferred.

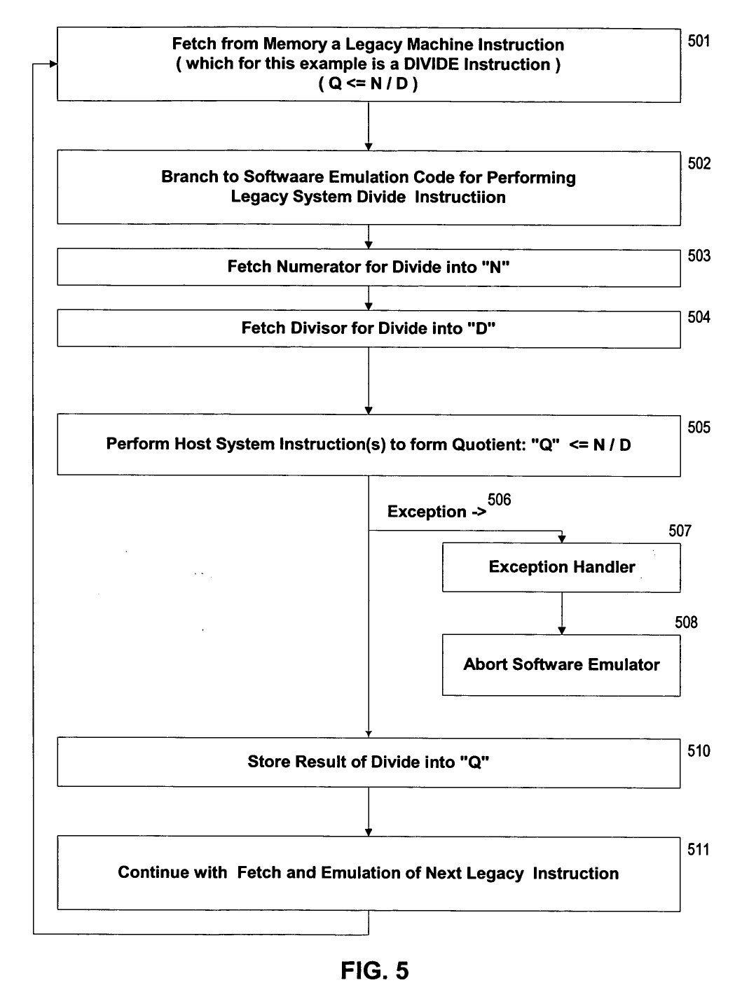

FIG. 5 is a flow diagram illustrating the pseudo-code of exemplary emulation software executing a host system divide instruction as part of the processing for one specific legacy system machine instruction. In this example the legacy instruction fetches two operands N and D, divides N by D and places the result into Q. The actual divide operation is performed by a host machine instruction, or sequence of instructions which divide two integer numbers. The host system divide instruction will typically “fault” if the divisor D is a zero. Without any signal handler or recovery mechanism in place which is the case for this example, the software program, which is the software emulator, will be aborted.

Referring to FIG. 5, the first step 501 is the fetch of the next legacy instruction which for this example is a divide instruction that on the legacy hardware platform would perform the function Q<=N divided by D, where Q, N, and D are integers. The opcode of the legacy instruction is discovered to be the divide instruction, and the software emulator takes a branch 502 to the code for performing the legacy system divide instruction. This code fetches both the numerator 503 and the denominator 504. Without checking, the host system code is instructed by the machine language of the software emulator to perform the instructions which do a divide operation 505 as an machine instruction on the host system hardware. If there is any exception 506, the exception handler 506, also known as the signal handler, receives control 507, which in this example is when a divide check occurs. If this or any other exception occurs the software emulator is aborted 508. If there is no exception, the signal handler does not gain control and the software emulator will proceed to complete the instruction emulation by storing the result of the divide instruction into “Q” 510 and then continue 511 in normal fashion with the fetch and emulation of the next legacy instruction.

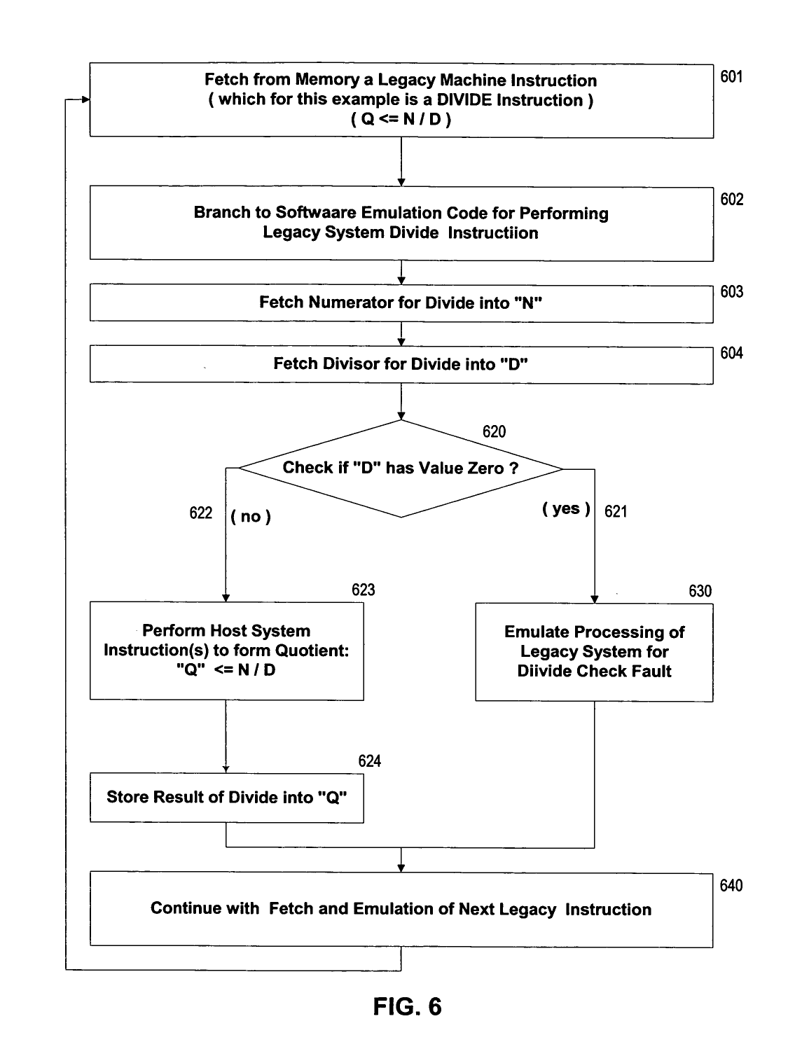

FIG. 6 is a flow diagram illustrating the checking for a condition that may potentially cause a hardware fault before the host system instruction that may take the fault is executed. The legacy machine instruction is fetched from memory and found to be a divide instruction 601. A branch is taken 602 by the software emulation code to the code for performing the emulation of the legacy system divide instruction. The numerator “N” is fetched 603, and the denominator “D” is fetched 604. In this example the software emulation code then includes a step 620 which checks the divisor D for value zero. If the divisor is not zero 622, then the divide is performed using a host system divide instruction 623 and the result is stored into “Q” 624. and emulation of the legacy instruction processing 640 continues. If a value of zero is found for the divisor 621, the software emulation branches to code 630 which emulates the behavior of the legacy system when that specific legacy instruction encounters a divisor of value zero. This avoids the taking of an unexpected exception on the host system hardware, but has the disadvantage of being slower for normal processing, because of the time for checking, when the exception condition does not occur. Once the emulation of the legacy system instruction is complete the emulation continues 640 with the next legacy instruction. Since the frequency of occurrence of these exceptions is typically very, very low this approach is slower than what could be achieved with an alternative approach.

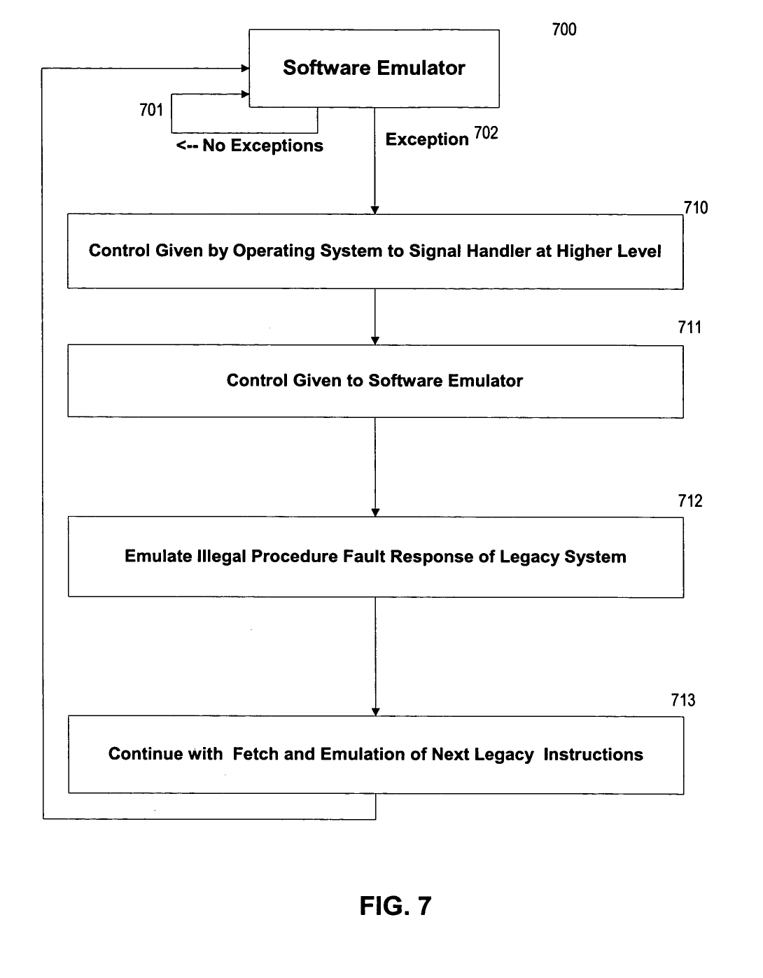

FIG. 7 is a flow diagram of an alternative approach illustrating the recovery from a hardware special case condition that was not checked but which was caught by a higher level signal handler. In this flow diagram the instruction that is being emulated at the time of the exception is aborted, but the emulation itself is resumed. That is, the emulation system performs in the manner of the legacy system when some type of illegal condition is encountered. The emulation of machine instructions continues so that the legacy operating system now has control of what will be the overall system response. The software emulation in normal operation is marked as 700. As long as no exception occurs 701 the software emulation continues normal emulation of the legacy instructions. If an exception does occur 702 control is given 710 to the operating system's signal handler which is at a higher level. The signal handler then hands control 711 to special code in the software emulator 712 for emulating the response of the system to an illegal procedure. The program that is in process cannot continue in normal fashion, so the illegal procedure fault will infoirm the operating system the program has faulted when normal emulation is continue 713.

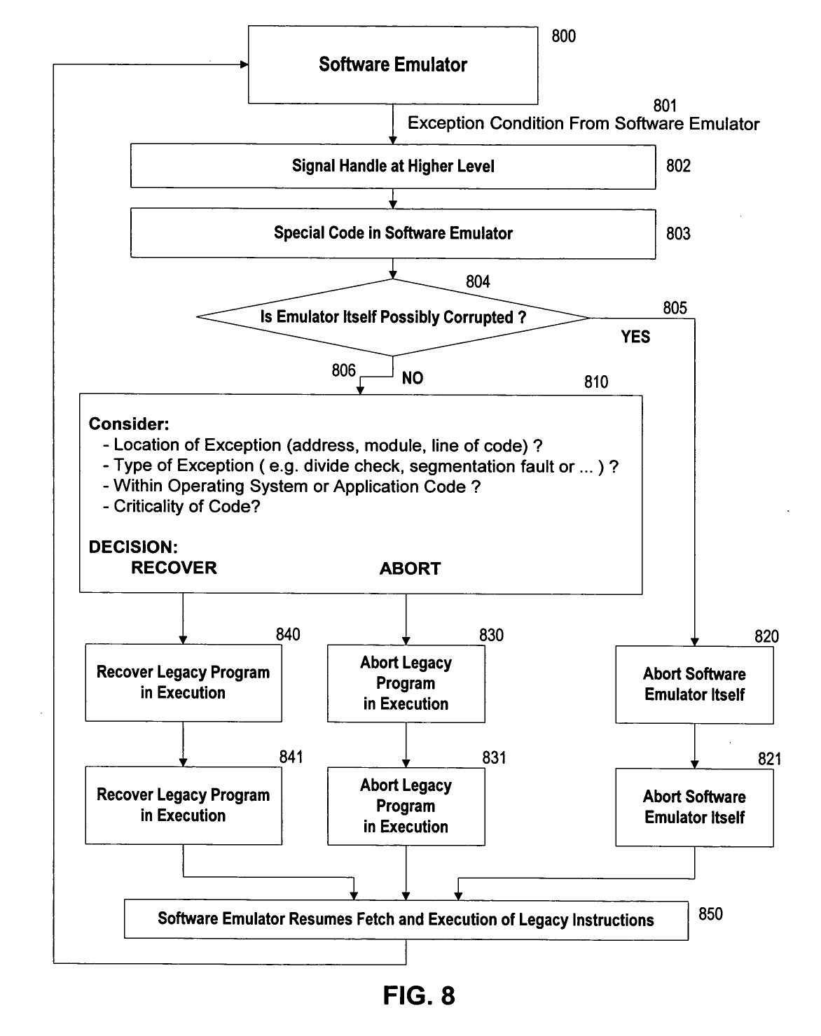

FIG. 8 is a diagram illustrating the determination of whether a signaled condition detected while running the emulation software should cause an abort, or recovery and resumption of emulation on behalf of the same program. The overriding principle in making the decision is whether emulation can be safely resumed with a minimal chance of system level data corruption, or corruption of the variables of the emulation code itself. If there is any significant chance of data corruption without detection, then the program being emulated should be aborted. If there is any significant chance of the emulator itself being corrupted then the emulation should abort itself. In a mainframe system, this is akin to a central processor detecting a hardware error. In an emulated central processor unit, this means that the software program or thread of execution relating to a specific processor must be restarted. Referring to FIG. 8, the software emulator in normal operation is marked as 800. As long as no exception occurs the software emulator 800 continues processing legacy system instructions. If an exception condition occurs 801 then control is given to a higher level signal handler 802. The signal handler determines which host system program was in execution at the time of the exception and then passes control to special code which is part of the software emulator 803. The mechanism for signal handling procedures is well known by those current in the state of the art for system level programming. The first determination that must be made is whether the exception condition indicates that the software emulator itself may be possibly corrupted 804. If there is a possible corruption 805 the software emulator itself must be aborted 820, and then if proper, the software emulator or a thread for the CPU will be reloaded and restarted in memory 821. The software emulator then proceeds with normal legacy instruction processing 850.

Continuing in reference to FIG. 8, if the software emulator itself is not in significant danger of corruption 806, then several other factors are considered 810 such as the type of exception condition, the location in memory of the host system instruction, whether or not the instruction is part of the host system operating system, a judgment as to the criticality of the code being emulated, and determining if the code is a lower level application program or not. Based on this information the legacy system program can be recovered 840 or aborted 830. If recovery is decided upon the software emulator will emulate the response of the legacy system hardware 841 and then resume legacy instruction processing 850. If recovery is not decided upon the software emulator will signal the legacy system operating system that an illegal procedure has been encountered and give control to the legacy operating system to abort the program in question 831. Normal legacy instruction processing then resumes 850.

Thus, while the principles of the invention have now been made clear in an illustrative embodiment, there will be immediately obvious to those skilled in the art many modifications of structure, arrangements, proportions, the elements, materials, and components, used in the practice of the invention which are particularly adapted for specific environments and operating requirements without departing from those principles.

What is claimed is:

1. Apparatus for emulating in software the hardware and operations of a target computer system including:
A) a central processing unit which is part of a host system;
B) a mass memory which is a part of a host system;
C) target system memory contained within said mass memory of the host system;
D) a signal handler which catches control of the software emulation program following a host system hardware detected exception condition;
E) a mechanism for determining the type of program being executed by the software emulator; and
F) a mechanism for determining whether the type of the program being executed by the software emulation should result in an abort of the software emulation program itself or as an alternative to continue by returning control to the software emulation program

2. The apparatus of claim 1 in which said determination of the type of program being emulated includes a distinction as to whether the program is a part of the legacy system's operating system.

3. Apparatus for emulating in software the hardware and operations of a target computer system including:
A) a central processing unit which is part of a host system;
B) a mass memory which is a part of a host system;
C) target system memory contained within said mass memory of the host system;
D) a signal handler which catches control of the software emulation program following a host system hardware detected exception condition;
E) a mechanism for determining the legacy system machine instruction being executed by the software emulator; and
F) a mechanism utilizing said determination of the legacy system machine instruction being executed to influence the choice of response by the signal handler in coordination with the software emulation program.

4. The apparatus of claim 3 in which said response by the signal handler in coordination with the software emulation program is further influenced by a determination as to whether the instruction being processed was a part of the legacy system's operating system.

5. The apparatus of claim 3 including also further mechanism for determining the legacy instruction being emulated based upon the memory location of the machine instruction;

6. Apparatus for emulating in software the hardware and operations of a target computer system including:
A) a central processing unit which is part of a host system;
B) a mass memory which is a part of a host system;
C) target system memory contained within said mass memory of the host system;
D) a signal handler which catches control of the software emulation program following a host system hardware detected exception condition;
E) a mechanism included in the code of the software emulator for recording flag information to the signal handler as to what is being done by the emulation code
F) the signal handler utilizing said flagging information as to what was being done by the emulation code to influence the response of the signal handler in coordination with the software emulation code.
